(19) United States
(12) Patent Application Publication
(10) Pub. No.: US 2024/0142948 A1
(43) Pub. Date: May 2, 2024

(54) Methods And Systems For Monitoring Metrology Fleet Productivity

(71) Applicant: KLA Corporation, Milpitas, CA (US)

(72) Inventors: Alexander Kuznetsov, Austin, TX (US); Xiaoyue Luo, McMinnville, OR (US)

(21) Appl. No.: 17/978,844

(22) Filed: Nov. 1, 2022

(51) Int. Cl. G05B 19/418; G06T 7/00

(52) U.S. Cl. CPC G05B 19/41815; G05B 19/4184; G05B 19/41865; G06T 7/0004

(57) ABSTRACT

Methods and systems for evaluating individual semiconductor metrology tool productivity based on both individual tool productivity metrics and fleet productivity metrics are described herein. Productivity metrics associated with each individual tool are combined with productivity metrics associated with a fleet of tools to identify problematic tools quickly and with fewer false positives. In particular, tool productivity results are obtained much more quickly in situations where productivity is driven by low frequency events. Values of one or more accuracy metrics indicative of a confidence in the ranking of individual tools among the fleet of measurement tools are estimated. In addition, a probability of a future failure event associated with an individual tool of the fleet of measurement tools is predicted based on a difference between a predicted probability distribution of the failure event and an actual, observed distribution of the failure event.

### TECHNICAL FIELD

The described embodiments relate to metrology systems and methods, and more particularly to methods and systems for improved measurement of semiconductor structures.

### BACKGROUND INFORMATION

Semiconductor devices such as logic and memory devices are typically fabricated by a sequence of processing steps applied to a specimen. The various features and multiple structural levels of the semiconductor devices are formed by these processing steps. For example, lithography among others is one semiconductor fabrication process that involves generating a pattern on a semiconductor wafer. Additional examples of semiconductor fabrication processes include, but are not limited to, chemical-mechanical polishing, etch, deposition, and ion implantation. Multiple semiconductor devices may be fabricated on a single semiconductor wafer and then separated into individual semiconductor devices.

Metrology processes are used at various steps during a semiconductor manufacturing process to detect defects on wafers to promote higher yield. Optical and X-ray based metrology techniques offer the potential for high throughput without the risk of sample destruction. A number of metrology based techniques including scatterometry, reflectometry, and ellipsometry implementations and associated analysis algorithms are commonly used to characterize critical dimensions, film thicknesses, composition, overlay and other parameters of nanoscale structures.

The performance, integration, and reliability of semiconductor devices have continuously improved over time due to enhanced process resolution and increasingly complex device structures. Increased process resolution enables a reduction in the minimum critical size of fabricated structures. Process resolution is primarily driven by the wavelength of the light source employed in the fabrication process. The latest Extreme Ultraviolet Lithography (EUV) light sources generate wavelengths of 13.5 nanometers; enabling fabrication of structural features smaller than 32 nanometers. In addition, more complex device structures, such as FinFET structures and vertical NAND structures, have been developed to improve overall performance, energy cost, integration level, and reliability.

As devices (e.g., logic and memory devices) move toward smaller nanometer-scale dimensions, characterization becomes more difficult. Devices incorporating complex three-dimensional geometry and materials with diverse physical properties contribute to characterization difficulty. In general, metrology systems are required to measure devices at more process steps and with higher precision.

In addition to accurate device characterization, measurement consistency across a range of measurement applications and a fleet of metrology systems tasked with the same measurement objective is also important. If measurement consistency degrades in a manufacturing environment, consistency among processed semiconductor wafers is lost and yield drops to unacceptable levels. Matching measurement results across applications and across multiple systems (i.e., tool-to-tool matching) ensures that measurement results on the same wafer for the same application yield the same result.

Productivity of a semiconductor fabrication facility is critical to achieve profitability in semiconductor manufacturing. Productivity is directly related to the productivity of individual tools. For example, a single underperforming tool creates a bottleneck that hampers the productivity of the entire production line. As such, it is critical that the productivity of each tool is monitored closely, and performance issues associated with each tool are addressed in a timely manner.

Traditionally, the productivity of each tool is monitored independently of other tools in a fleet. Typically, individual tool productivity metrics are expressed statistically, e.g., mean, standard deviation, etc. Furthermore, decisions regarding the need for intervention are based on the values of individual tool productivity metrics. In one example, a tool reset rate, e.g., number of tool resets per month, is calculated independently for each tool in the fleet. The tool reset rate characterizes individual tool productivity. The tool reset rate for each individual tool is compared to a baseline and performance of underperforming tools is addressed.

Evaluating productivity based on individual tool productivity metrics suffers from lack of robustness. Typically, production tools operating in a fabrication facility encounter relatively few reset events. A single reset event can trigger the individual tool productivity metric to fall outside of an acceptable baseline range of values. In other words, the signal provided by the individual productivity metric is overcome by noise because the events that drive the signal value are so infrequent.

An attempt to resolve this issue is to simply evaluate individual tool productivity metrics over a longer period of time to improve calculation robustness. For example, the tool reset rate may be calculated as an average tool reset rate over many weeks or months. Unfortunately, this approach suffers from several important limitations. First, extending the period of time to evaluate individual tool productivity delays the discovery of underperforming tools and degrades overall fabrication facility productivity for long periods of time. Second, extending the period of time to evaluate individual tool productivity introduces inaccuracy because the baseline range of acceptable values may shift during the prolonged time interval.

As metrology systems have evolved to measure devices at more process steps and with higher accuracy, the evaluation of fleet productivity has become more complex and less effective. Improved methods and tools to reduce the time and cost associated with maintaining high productivity across a fleet of metrology tools are desired.

### SUMMARY

Methods and systems for evaluating individual semiconductor metrology tool productivity based on both individual tool productivity metrics and fleet productivity metrics are described herein. The accuracy, speed, and robustness of each individual tool productivity evaluation is improved by including both individual and fleet productivity metrics. Productivity metrics associated with each individual tool are combined with productivity metrics associated with a fleet of tools to identify problematic tools quickly and with fewer false positives. In particular, tool productivity results are obtained much more quickly in situations where productivity is driven by low frequency events.

A fleet productivity evaluation engine characterizes the productivity of each measurement tool of a fleet of measurement tools and ranks the measurement systems in order of productivity. The ranking can then be employed by a user to guide decisions regarding tool repair and maintenance.

A productivity data set includes data indicative of individual tool performance characteristics collected from a number of individual tools of a fleet of semiconductor measurement tools. By way of non-limiting example, performance characteristics indicative of tool productivity include tool downtime rate, duration of tool downtime, tool reset rate, time between unscheduled resets, etc. Productivity metrics are employed to numerically characterize individual tool and fleet productivity. In general, values of one or more individual tool productivity metrics characterizing the performance of each individual tool of a fleet of measurement tools are determined independently from values of one or more fleet productivity metrics characterizing the performance of the fleet of measurement tools.

Individual tool based productivity metric values associated with each individual tool are determined from data productivity data corresponding to each individual tool in the productivity data set. Similarly, fleet based productivity metric values are determined from data productivity data corresponding to the fleet of individual tools in the productivity data set.

In some examples, individual tool productivity metrics and fleet productivity metrics are determined based on simple statistical measures, e.g., mean value and standard deviation of a distribution of performance data, median value of a distribution of performance data, harmonic mean value of a distribution of performance data, slope of a linear regression performed on a distribution of performance data, etc.

In some other examples, individual tool productivity metrics and fleet productivity metrics are determined based on a fit of performance data to an analytical function, e.g., Gaussian function, Poisson function, etc. In some of these examples the productivity metric values characterizing the performance of an individual tool or a fleet of tools is a parameter of the analytical model.

In some other examples, individual tool productivity metrics and fleet productivity metrics are determined based on a trained machine-learning (ML) based model.

In one aspect, values of one or more combined productivity metrics associated with each of the individual tools of the fleet of measurement tools are determined based on the values of the one or more individual tool productivity metrics associated with each individual tool and the values of the one or more fleet productivity metrics.

In some examples, fleet productivity metrics and individual tool based productivity metrics are combined by selecting a relevant subset of both fleet and individual tool based metrics. In some of these examples, a combined productivity metric is determined by comparing values of individual tool productivity metrics relative to values of corresponding fleet productivity metrics. In one example, the difference between a mean value of the tool reset rate associated with each individual tool is compared to the average value of the tool reset rate associated with all of the individual tools in the fleet. Each difference is a combined productivity metric value associated with the corresponding individual tool.

In some other examples, a combined productivity metric is determined based on a statistical distance between a distribution of individual tool based productivity metric values and a distribution of fleet based productivity metric values. The statistical difference is employed to quantify how an individual tool differs from the fleet of tools.

In a further aspect, the individual tools of the fleet of measurement tools are ranked based on the values of one or more combined productivity metrics. If an individual tool is underperforming, the individual tool is selected for an intervention, i.e., maintenance, repair, or both, in the ranked order determined by the values of the one or more combined productivity metrics. Furthermore, the ranking of individual tools may be based on one or more combined productivity metrics and one or more individual productivity metrics.

In some examples, individual tools are ranked based on at least one combined productivity metric. In some other examples, individual tools are ranked based on at least one combined productivity metric and an individual productivity metric.

In another further aspect, values of one or more accuracy metrics are estimated. The accuracy metrics are indicative of a confidence in the ranking of individual tools among the fleet of measurement tools.

In another further aspect, a probability of a future failure event associated with at least one individual tool of the fleet of measurement tools is predicted based on a difference between a predicted probability distribution of the failure event and an actual, observed distribution of the failure event.

The foregoing is a summary and thus contains, by necessity, simplifications, generalizations and omissions of detail; consequently, those skilled in the art will appreciate that the summary is illustrative only and is not limiting in any way. Other aspects, inventive features, and advantages of the devices and/or processes described herein will become apparent in the non-limiting detailed description set forth herein.

### BRIEF DESCRIPTION OF THE DRAWINGS

FIG. 1 is a diagram illustrative of an embodiment of an optical metrology tool for measuring characteristics of a specimen in accordance with the exemplary methods presented herein.

FIG. 2 is a diagram illustrative of a fleet productivity evaluation engine in one embodiment.

FIG. 3 depicts a chart illustrative of the mean value of the tool reset rate associated with each individual tool of a fleet of measurement tools.

FIG. 4 depicts a chart illustrative of the standard deviation of the tool reset rate associated with each individual tool of a fleet of measurement tools.

FIG. 5 depicts a chart illustrative of a histogram plot of the tool reset rate associated with the fleet of tools.

FIG. 6 depicts a chart illustrative of the KL divergence associated with each individual tool of the fleet of measurement tools for tool reset rate.

FIG. 7 depicts a chart illustrative of the KL divergence as illustrated in FIG. 6 with bars associated with individual tools having a mean value of tool reset rate below the fleet average are plotted transparently, while the bars associated with individual tools having a mean value of tool reset rate above the fleet average are shaded.

FIG. 8 depicts a chart of accuracy metric values associated with the KL divergence calculations associated with each tool of the fleet of tools.

FIG. 9 illustrates a flowchart of a method 200 for evaluating the productivity of a fleet of semiconductor measurement systems in at least one novel aspect.

### DETAILED DESCRIPTION

Reference will now be made in detail to background examples and some embodiments of the invention, examples of which are illustrated in the accompanying drawings.

Methods and systems for evaluating individual semiconductor metrology tool productivity based on both individual tool productivity metrics and fleet productivity metrics are described herein. By including both individual and fleet productivity metrics, the accuracy, speed, and robustness of each individual tool productivity evaluation is improved. Productivity metrics associated with each individual tool are combined with productivity metrics associated with a fleet of tools to identify problematic tools quickly and with fewer false positives. In particular, tool productivity results are obtained much more quickly in situations where productivity is driven by low frequency events.

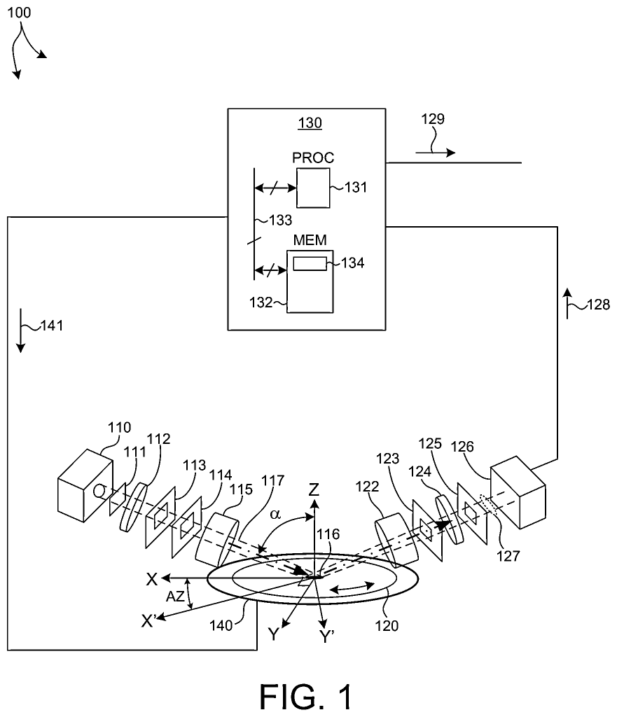

FIG. 1 depicts an exemplary, metrology system 100 for performing measurements of structural features of semiconductor devices in accordance with the exemplary methods presented herein. As depicted in FIG. 1, metrology system 100 is configured as a broadband spectroscopic ellipsometer configured to perform measurements of a structure within a measurement area 116 of a specimen 120 disposed on a specimen positioning system 140. However, in general, metrology system 100 may be configured as any semiconductor metrology tool or inspection tool including, but not limited to optical based semiconductor measurement tools, x-ray based semiconductor measurement tools, electron beam based semiconductor measurement tools, etc.

Metrology system 100 includes an illumination source 110 that generates a beam of illumination light 117 incident on a wafer 120. In some embodiments, illumination source 110 is a broadband illumination source that emits illumination light in the ultraviolet, visible, and infrared spectra. In one embodiment, illumination source 110 is a laser sustained plasma (LSP) light source (a.k.a., laser driven plasma source). The pump laser of the LSP light source may be continuous wave or pulsed. A laser-driven plasma source can produce significantly more photons than a Xenon lamp across a wavelength range from 150 nanometers to 2000 nanometers. Illumination source 110 can be a single light source or a combination of a plurality of broadband or discrete wavelength light sources. The light generated by illumination source 110 includes a continuous spectrum or parts of a continuous spectrum, from ultraviolet to infrared (e.g., vacuum ultraviolet to mid infrared). In general, illumination light source 110 may include a super continuum laser source, an infrared helium-neon laser source, an arc lamp, or any other suitable light source.

In a further aspect, the amount of illumination light is broadband illumination light that includes a range of wavelengths spanning at least 500 nanometers. In one example, the broadband illumination light includes wavelengths below 250 nanometers and wavelengths above 750 nanometers. In general, the broadband illumination light includes wavelengths between 120 nanometers and 3,000 nanometers. In some embodiments, broadband illumination light including wavelengths beyond 3,000 nanometers may be employed.

As depicted in FIG. 1, metrology system 100 includes an illumination subsystem configured to direct illumination light 117 to one or more structures formed on the wafer 120. The illumination subsystem is shown to include light source 110, one or more optical filters 111, polarizing component 112, field stop 113, aperture stop 114, and illumination optics 115. The one or more optical filters 111 are used to control light level, spectral output, or both, from the illumination subsystem. In some examples, one or more multi-zone filters are employed as optical filters 111. Polarizing component 112 generates the desired polarization state exiting the illumination subsystem. In some embodiments, the polarizing component is a polarizer, a compensator, or both, and may include any suitable commercially available polarizing component. The polarizing component can be fixed, rotatable to different fixed positions, or continuously rotating. Although the illumination subsystem depicted in FIG. 1 includes one polarizing component, the illumination subsystem may include more than one polarizing component. Field stop 113 controls the field of view (FOV) of the illumination subsystem and may include any suitable commercially available field stop. Aperture stop 114 controls the numerical aperture (NA) of the illumination subsystem and may include any suitable commercially available aperture stop. Light from illumination source 110 is directed through illumination optics 115 to be focused on one or more structures (not shown in FIG. 1) on wafer 120. The illumination subsystem may include any type and arrangement of optical filter(s) 111, polarizing component 112, field stop 113, aperture stop 114, and illumination optics 115 known in the art of spectroscopic ellipsometry, reflectometry, and scatterometry.

As depicted, in FIG. 1, the beam of illumination light 117 passes through optical filter(s) 111, polarizing component 112, field stop 113, aperture stop 114, and illumination optics 115 as the beam propagates from the illumination source 110 to wafer 120. Beam 117 illuminates a portion of wafer 120 over a measurement spot 116.

Metrology system 100 also includes a collection optics subsystem configured to collect light generated by the interaction between the one or more structures and the incident illumination beam 117. A beam of collected light 127 is collected from measurement spot 116 by collection optics 122. Collected light 127 passes through collection aperture stop 123, polarizing element 124, and field stop 125 of the collection optics subsystem.

Collection optics 122 includes any suitable optical elements to collect light from the one or more structures formed on wafer 120. Collection aperture stop 123 controls the NA of the collection optics subsystem. Polarizing element 124 analyzes the desired polarization state. The polarizing element 124 is a polarizer or a compensator. The polarizing element 124 can be fixed, rotatable to different fixed positions, or continuously rotating. Although the collection subsystem depicted in FIG. 1 includes one polarizing element, the collection subsystem may include more than one polarizing element. Collection field stop 125 controls the field of view of the collection subsystem. The collection subsystem takes light from wafer 120 and directs the light through collection optics 122, and polarizing element 124 to be focused on collection field stop 125. In some embodiments, collection field stop 125 is used as a spectrometer slit for the spectrometers of the detection subsystem. However, collection field stop 125 may be located at or near a spectrometer slit of the spectrometers of the detection subsystem.

The collection subsystem may include any type and arrangement of collection optics 122, aperture stop 123, polarizing element 124, and field stop 125 known in the art of spectroscopic ellipsometry, reflectometry, and scatterometry.

In the embodiment depicted in FIG. 1, the collection optics subsystem directs light to spectrometer 126. Spectrometer 126 generates output responsive to light collected from the one or more structures illuminated by the illumination subsystem. In one example, the detectors of spectrometer 126 are charge coupled devices (CCD) sensitive to ultraviolet and visible light (e.g., light having wavelengths between 190 nanometers and 860 nanometers). In other examples, one or more of the detectors of spectrometer 126 is a photo detector array (PDA) sensitive to infrared light (e.g., light having wavelengths between 950 nanometers and 2500 nanometers). However, in general, other detector technologies may be contemplated (e.g., a position sensitive detector (PSD), an infrared detector, a photovoltaic detector, etc.). Each detector converts the incident light into electrical signals indicative of the spectral intensity of the incident light. In general, spectrometer 126 generates output signals 128 indicative of the spectral response of the structure under measurement to the illumination light.

Wafer stage 140 positions wafer 120 with respect to the ellipsometer. In some embodiments, wafer stage 140 moves wafer 120 in the XY plane by combining two orthogonal, translational movements (e.g., movements in the X and Y directions) to position wafer 120 with respect to the ellipsometer. In some embodiments, wafer stage 140 is configured to control the orientation of wafer 120 with respect to the illumination provided by the optical ellipsometer in six degrees of freedom. In one embodiment, wafer stage 140 is configured to control the azimuth angle, AZ, of wafer 120 with respect to the illumination provided by the optical ellipsometer by rotation about the z-axis. In general, specimen positioning system 140 may include any suitable combination of mechanical elements to achieve the desired linear and angular positioning performance, including, but not limited to goniometer stages, hexapod stages, angular stages, and linear stages. Computing system 130 is communicatively coupled to wafer stage 140 and communicates motion command signals 141 to wafer stage 140. In response, wafer stage 140 positions wafer 120 with respect to the ellipsometer in accordance with the motion control commands.

Metrology system 100 also includes computing system 130 employed to acquire signals 128 generated by detector 126 and determine properties of the structure of interest based at least in part on the acquired signals. As depicted in FIG. 1, computing system 130 is configured to receive signals 128 indicative of the measured spectral response of the structure of interest and estimate values 129 of one or more parameters of interest, e.g., CD, overlay, wafer tilt, etc., based on the measured spectral response.

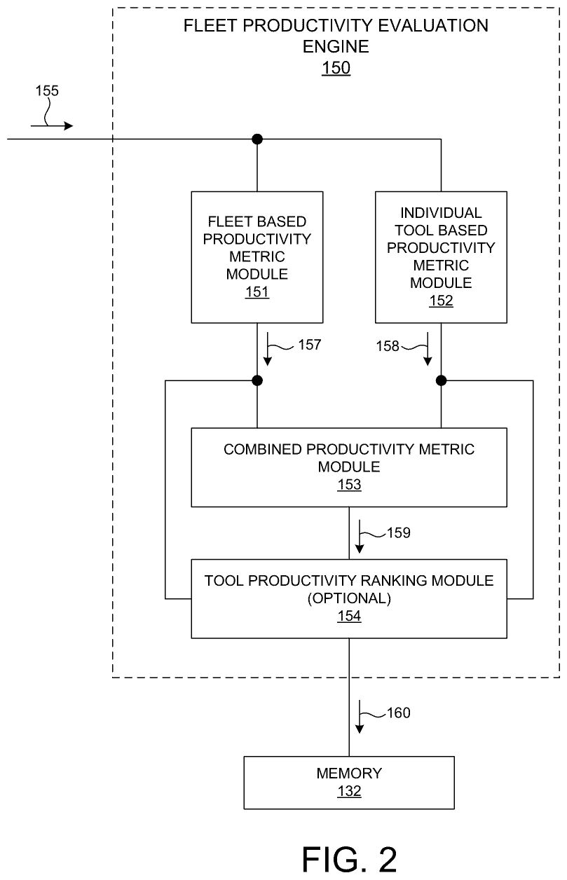

FIG. 2 depicts an illustration of an embodiment of a fleet productivity evaluation engine 150 to characterize the productivity of each measurement tool of a fleet of measurement tools and rank the measurement systems in order of productivity. The ranking can then be employed by a user to guide decisions regarding tool repair and maintenance. In some embodiments, computing system 130 is configured as a fleet productivity evaluation engine 150 as described herein. However, in general, any suitable computing system communicatively coupled to a fleet of measurement tools may be configured as a fleet productivity evaluation engine 150 as described herein.

As depicted in FIG. 2, an exemplary fleet productivity evaluation engine 150 includes a trained quality control encoder module 152, a fleet based productivity metric module 151, an individual tool based productivity metric module 152, and combined productivity metric module 153, and optionally, a tool productivity ranking module 154.

As depicted in FIG. 2, a productivity data set 155 is received by fleet productivity evaluation engine 150. Productivity data set 155 includes data indicative of individual tool performance characteristics collected from a number of individual tools of a fleet of semiconductor measurement tools. In some examples, a productivity data set 155 may be communicated from a metrology tool, e.g., metrology tool 100, a network accessible computing system configured to store productivity data collected from one or more metrology systems, a network accessible data storage system configured to store productivity data collected from one or more metrology systems, or any combination thereof. By way of non-limiting example, performance characteristics indicative of tool productivity include tool downtime rate, duration of tool downtime, tool reset rate, time between unscheduled resets, etc.

In one example, measurement system 100 depicted in FIG. 1 is an individual tool of a fleet of semiconductor measurement tools employed in a semiconductor fabrication facility. However, in general, a fleet of measurement tools may include any number of identical or different measurement tools employed in a semiconductor fabrication facility.

Productivity metrics are employed to numerically characterize individual tool and fleet productivity. In general, values of one or more individual tool productivity metrics characterizing the performance of each individual tool of a fleet of measurement tools are determined independently from values of one or more fleet productivity metrics characterizing the performance of the fleet of measurement tools.

As depicted in FIG. 2, productivity data set 155 is communicated to individual tool based productivity metric module 152. Individual tool based productivity metric module 152 determines one or more individual tool productivity metrics 158 associated with each individual tool from data productivity data corresponding to each individual tool in the productivity data set 155.

Similarly, productivity data set 155 is communicated to fleet based productivity metric module 151. Fleet based productivity metric module 151 determines one or more fleet productivity metrics 157 associated with the fleet of individual tools from data productivity data corresponding to the individual tools of the fleet of individual tools in the productivity data set 155.

In some examples, individual tool productivity metrics and fleet productivity metrics are determined based on simple statistical measures, e.g., mean value and standard deviation of a distribution of performance data, median value of a distribution of performance data, harmonic mean value of a distribution of performance data, slope of a linear regression performed on a distribution of performance data, etc.

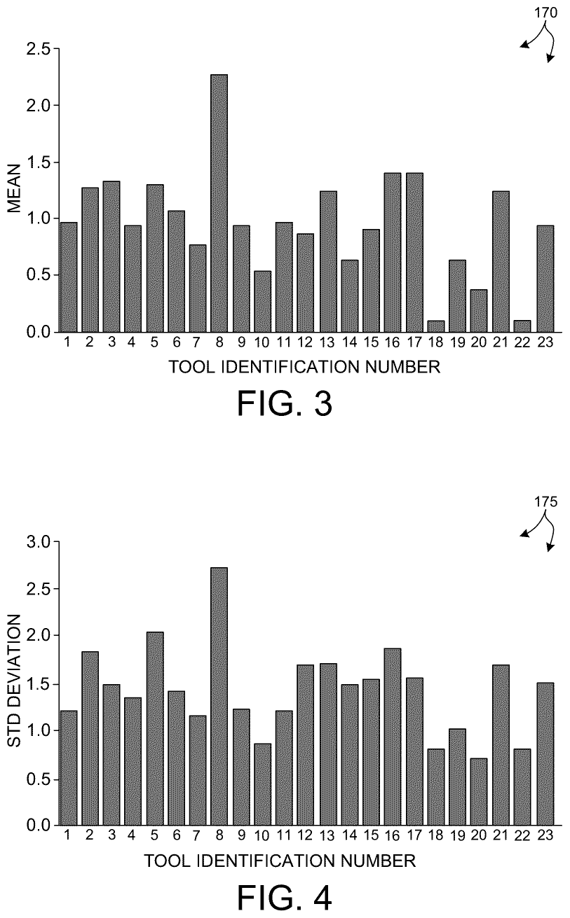

FIG. 3 depicts a chart 170 illustrative of the mean value of the tool reset rate associated with each individual tool of a fleet of 23 measurement tools. Each individual tool is assigned a tool identification number plotted on the x-axis. The mean value of the number of resets per unit of time is plotted on the y-axis. FIG. 4 depicts a chart 175 illustrative of the standard deviation of the distribution of the tool reset rate associated with each individual tool of the fleet of 23 measurement tools.

The mean value depicted in FIG. 3 and the standard deviation depicted in FIG. 4 are two statistically based individual tool productivity metrics 158 employed to characterize the productivity of each of the 23 tools of the fleet of measurement tools.

In some other examples, individual tool productivity metrics and fleet productivity metrics are determined based on a fit of performance data to an analytical function, e.g., Gaussian function, Poisson function, etc. In some of these examples the productivity metric values characterizing the performance of an individual tool or a fleet of tools is a parameter of the analytical model.

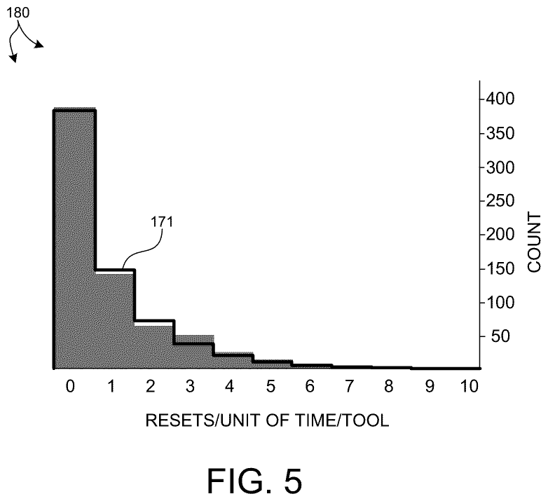

FIG. 5 depicts a chart 180 illustrative of a histogram plot of the tool reset rate associated with the fleet of 23 tools. As depicted in FIG. 5, the x-axis is subdivided into 11 different event bins. Each event bin represents a different number of resets per unit of time per tool. The number of events corresponding to each event bin is plotted along the y-axis. For example, among the data set describing the number of resets over time among the fleet of 23 tools, there were over 350 events where there were zero resets over unit time, e.g., two weeks, among each individual tool of the fleet of 23 tools. Similarly, there were over 100 events where there was one reset over unit time, e.g., two weeks, among each individual tool of the fleet of 23 tools, etc.

The distribution of reset events per unit time across the fleet of 23 tools is described by an analytical function 171. As depicted in FIG. 5, a Gamma-Poisson function 171 is fit to the tool reset rate data set to accurately describe fleet productivity. In this example, the fleet productivity metrics 157 characterizing the tool reset rate of the fleet of 23 tools are fitting parameters characterizing the Gamma-Poisson function 171 fit to the tool reset rate distribution plotted in FIG. 5. Although a Gamma-Poisson function may be employed to describe a distribution of events across a fleet of tools, in general, any suitable mathematical function may be employed, e.g., an exponential distribution, etc. In another example, fleet productivity metrics 157 characterizing fleet performance, e.g., reset events per unit time, are the expected value and variance associated with a Gaussian fit to the productivity data set 155.

In some other examples, individual tool productivity metrics and fleet productivity metrics are determined based on a trained machine-learning (ML) based model. The ML based model is trained based on actual performance data, simulated performance data, or both. In some of these examples the productivity metric values characterizing the performance of an individual tool or a fleet of tools is a parameter of the ML based model. In some examples, incoming performance data is analyzed based on the trained ML model to arrive at values of individual tool productivity metrics and fleet productivity metrics. In one example, principle component analysis is employed to transform incoming performance data into productivity metric values using a trained ML model.

In one aspect, values of one or more combined productivity metrics associated with each of the individual tools of the fleet of measurement tools are determined based on the values of the one or more individual tool productivity metrics associated with each individual tool and the values of the one or more fleet productivity metrics.

As depicted in FIG. 2, values of fleet productivity metrics 157 and values of individual tool productivity metrics 158 are communicated to combined productivity metric module 153. Combined productivity metric module 153 determines values of one or more combined productivity metrics 159 based on the values of the fleet productivity metrics 157 and the values of the individual tool productivity metrics 158.

In some examples, fleet productivity metrics and individual tool based productivity metrics are combined by selecting a relevant subset of both fleet and individual tool based metrics. In some of these examples, a combined productivity metric is determined by comparing values of individual tool productivity metrics relative to values of corresponding fleet productivity metrics. In one example, the difference between a mean value of the tool reset rate associated with each individual tool is compared to the average value of the tool reset rate associated with all of the individual tools in the fleet. Each difference is a combined productivity metric value associated with the corresponding individual tool.

In some other examples, a combined productivity metric is determined based on a statistical distance between a distribution of individual tool based productivity metric values and a distribution of fleet based productivity metric values. The statistical difference is employed to quantify how an individual tool differs from the fleet of tools.

In one example, a statistical distance is determined as the Kullback-Leibler (KL) divergence illustrated in equation (1), where P(x) is a discrete probability distribution of resets for a single tool, and Q(x) is a discrete probability distribution of resets for the fleet.

$$KL Divergence = {\sum }_{x} P ( x ) log ( \frac{P ( x )}{Q ( x )} ) \qquad ( 1 )$$

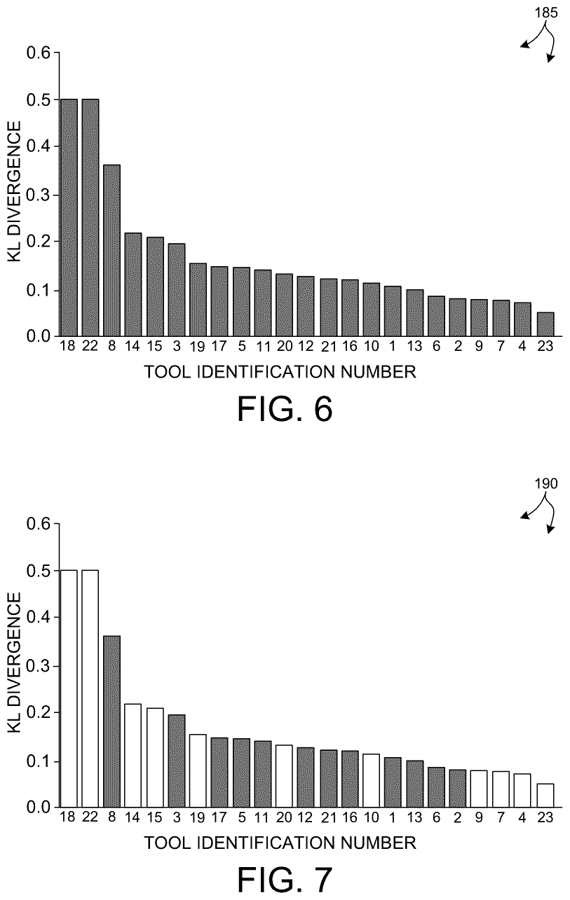

FIG. 6 depicts a chart 185 illustrative of the KL divergence associated with each individual tool of the fleet of 23 measurement tools for tool reset rate. Each individual tool is assigned a tool identification number plotted on the x-axis. The KL divergence value is plotted on the y-axis. As depicted in FIG. 6, the individual tools are plotted in descending order of KL divergence value. Tools with larger values of KL divergence have a distribution of tool reset rate that diverges from the fleet distribution of tool reset rate. Conversely, tools with smaller values of KL divergence have a distribution of tool reset rate that compares more closely with the fleet distribution of tool reset rate.

In a further aspect, the individual tools of the fleet of measurement tools are ranked based on the values of one or more combined productivity metrics. If an individual tool is underperforming, the individual tool is selected for an intervention, i.e., maintenance, repair, or both, in the ranked order determined by the values of the one or more combined productivity metrics. Furthermore, the ranking of individual tools may be based on one or more combined productivity metrics and one or more individual productivity metrics.

As depicted in FIG. 2, values of combined productivity metrics 159, fleet productivity metrics 157, and individual tool productivity metrics 158 are communicated to tool productivity ranking module 154. Tool productivity ranking module 154 ranks the individual tools in order of urgency to initiate a maintenance/repair operation based at least in part on the values of one or more combined productivity metrics. The tool productivity ranking 160 is communicated to a memory, e.g., memory 132.

In some examples, individual tools are ranked based on at least one combined productivity metric. For example, as depicted in FIG. 6, individual tools are ranked based on KL divergence value. In one example, individual tools are selected for an intervention, i.e., maintenance, repair, or both, based on KL divergence value. In the example depicted in FIG. 6, tool 18 would be selected for intervention first, then tool 22, then tool 8, etc.

In some other examples, individual tools are ranked based on at least one combined productivity metric and an individual productivity metric. For example, KL divergence provides a measure of how the distribution of an individual distribution compares to the fleet distribution. However, the performance of an individual tool with a relatively large KL divergence value may be performing exceptionally well or exceptionally poorly. To resolve this dilemma, in some examples, the mean value of the tool reset rate associated with each individual tool is compared to the average value of the tool reset rate associated with all of the individual tools in the fleet. Tools having a mean value of tool reset rate below the fleet average are considered acceptable, and tools having a mean value of tool reset rate above the fleet average are considered for an intervention, i.e., maintenance, repair, or both. In some other examples, the standard deviation of the tool reset rate associated with each individual tool is compared to the standard deviation of the tool reset rate associated with the fleet. Tools having a standard deviation of tool reset rate below the fleet are considered acceptable, and tools having a standard deviation of tool reset rate above the fleet are considered for an intervention, i.e., maintenance, repair, or both. In some other examples, both the mean value and the standard deviation of the tool reset rate associated with each individual tool is compared to the mean value and standard deviation of the tool reset rate associated with the fleet. Tools having both mean value and standard deviation of tool reset rate above the fleet are considered for an intervention, i.e., maintenance, repair, or both.

FIG. 7 depicts a chart 190 illustrative of the KL divergence associated with each individual tool of the fleet of 23 measurement tools for tool reset rate as illustrated in FIG. 6. However, the bars associated with individual tools having a mean value of tool reset rate below the fleet average are plotted transparently, while the bars associated with individual tools having a mean value of tool reset rate above the fleet average are shaded. As illustrated in FIG. 7, although tools 18 and 22 have relatively high KL divergence values, the mean value of tool reset rate is below average for both tools. Thus, these tools are performing exceptionally well. Hence, in the example depicted in FIG. 7, tool 8 would be selected for intervention first, then tool 3, then tool 17, etc.

In general, tools may be ranked based on any number of productivity metrics. In one example, tools are ranked based on tool reset rate and time to repair. In this example, it may be advantageous to prioritize tools that can be repaired more quickly over tools having worse productivity to improve overall fleet performance in a shorter period of time. In another example, tools are ranked based on tool reset rate and tool impact on overall factory productivity. In this example, it may be advantageous to prioritize tools that have a greater impact on overall factory productivity over tools having worse individual productivity to improve overall fleet performance.

In some examples, user input is received by a fleet productivity evaluation engine to determine which productivity metrics to utilize in an analysis and the relative importance of the selected productivity metrics. Furthermore, user input may also be employed to determine combinations of individual and fleet metrics that are relevant to tool productivity monitoring. In general, there are many different tool characteristics responsible for the overall performance of a measurement tool, and the most relevant productivity metrics are different depending on the measurement tool use case. In some examples, it may be most important to minimize tool downtime. In other examples, it may be most important to minimize the rate of unscheduled tool resets.

In another further aspect, values of one or more accuracy metrics are estimated. The accuracy metrics are indicative of a confidence in the ranking of individual tools among the fleet of measurement tools. In some examples, a p-value analysis is employed to estimate the p-value associated with statistically derived productivity metrics. In some examples, a goodness of fit analysis is employed to estimate values of one or more goodness of fit parameters, e.g., residual value, etc., associated with model based productivity metrics.

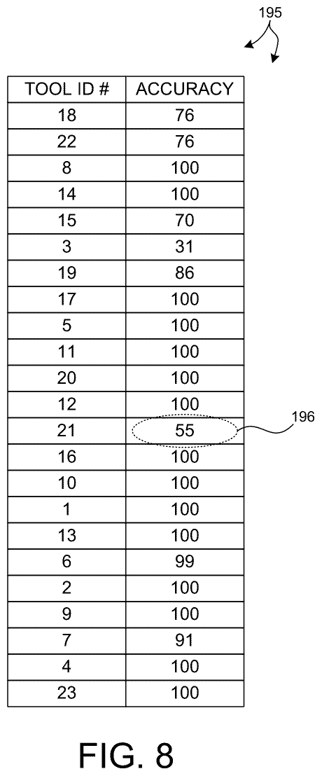

In one example, the uncertainty associated with the calculation of a mean value of a productivity metric is high when there are not enough data points, e.g., tool was idle for a long period of time. FIG. 8 depicts a chart 195 of accuracy metric values associated with mean value and standard deviation calculations associated with a productivity metric, e.g., tool reset rate, associated with each tool of the fleet of 23 tools. As depicted in FIG. 8, the accuracy metric value 196 associated with tool 21 is relatively small. In this example, the accuracy metric value 196 is the p-value associated with the mean value and standard deviation calculations associated with tool 21. The relatively low p-value indicates high uncertainty/low confidence in the approximation of mean value and standard deviation using the available data set.

In another further aspect, a probability of a future failure event associated with at least one individual tool of the fleet of measurement tools is predicted based on a difference between a predicted probability distribution of the failure event and an actual, observed distribution of the failure event. In this manner, predictions of future tool performance, such as tool downtime rate, tool reset rate and time between resets, are realized. Performance predictions enable early intervention to further improve productivity. In addition, one or more accuracy metrics indicative of a confidence in the prediction of future tool performance are calculated as described hereinbefore. In this manner, confidence in the predictions of future failure events can be taken into consideration when determining whether an early intervention action should be undertaken.

In one example, the predicted number of future reset events associated with each tool is determined based on an analytical fit to the actual reset probability distribution. P(N) denotes the predicted probability of having N resets. P(N) is calculated using individual tool statistics or fleet statistics. In addition, the number of resets that have occurred in the past is known for each tool in the fleet. The frequency of observed reset events, ObsFreq(N), is determined based on the known reset history. The probability of N resets in the future is determined by comparing the predicted value, P(N), to the observed value ObsFreq(N). The probability of N resets in the future is employed as a prediction of the frequency of future reset events for each tool. In addition, a p-value analysis of the statistically derived productivity metrics is employed to estimate the confidence level of the prediction of the frequency of future reset events. A relatively low p-value indicates high uncertainty/low confidence in the prediction of the frequency of future reset events.

In another aspect, the metrology tools comprising a fleet of metrology tools as described herein may include the same or different types of metrology tools. By way of non-limiting example, individual tools of a fleet of measurement tools include any of a spectroscopic ellipsometer, a spectroscopic reflectometer, a soft X-ray reflectometer, a small-angle x-ray scatterometer, an imaging system, a hyperspectral imaging system, a scatterometry overlay metrology system, etc. In one example, a fleet of five metrology tools may include three spectroscopic ellipsometery (SE) metrology tools and two SAXS metrology tools.

In general, an individual semiconductor measurement tool is any measurement tool employed in a semiconductor manufacturing facility, including a semiconductor metrology tool, a semiconductor inspection tool, etc. An individual semiconductor measurement tool may be optical based, x-ray based, electron beam based, or any combination thereof. Furthermore, a fleet of individual semiconductor measurement tools may include one or more optical based semiconductor measurement tools, one or more x-ray based semiconductor measurement tools, one or more electron beam based semiconductor measurement tools, or any combination thereof.

As depicted in FIG. 1, system 100 includes a single measurement technology (i.e., SE). However, in general, system 100 may include any number of different measurement technologies. By way of non-limiting example, system 100 may be configured as a reflective small angle x-ray scatterometer, a soft X-ray reflectometer, spectroscopic ellipsometer (including Mueller matrix ellipsometry), a spectroscopic reflectometer, a spectroscopic scatterometer, an overlay scatterometer, an angular resolved beam profile reflectometer, a polarization resolved beam profile reflectometer, a beam profile reflectometer, a beam profile ellipsometer, any single or multiple wavelength ellipsometer, a hyperspectral imaging system, or any combination thereof. Furthermore, in general, measurement data collected by different measurement technologies and analyzed in accordance with the methods described herein may be collected from multiple tools, a single tool integrating multiple technologies, or a combination thereof.

In a further embodiment, system 100 may include one or more computing systems 130 employed to perform measurements of structures and estimate values of parameters of interest in accordance with the methods described herein. The one or more computing systems 130 may be communicatively coupled to the detector 116. In one aspect, the one or more computing systems 130 are configured to receive measurement data 126 associated with measurements of a structure under measurement (e.g., structure disposed on specimen 120).

In yet another further aspect, the measurement results described herein can be used to provide active feedback to the process tool (e.g., lithography tool, etch tool, deposition tool, etc.). For example, values of measured parameters determined based on measurement methods described herein can be communicated to an etch tool to adjust the etch time to achieve a desired etch depth. In a similar way etch parameters (e.g., etch time, diffusivity, etc.) or deposition parameters (e.g., time, concentration, etc.) may be included in a measurement model to provide active feedback to etch tools or deposition tools, respectively. In some example, corrections to process parameters determined based on measured device parameter values may be communicated to the process tool. In one embodiment, computing system 130 determines values of one or more parameters of interest. In addition, computing system 130 communicates control commands to a process controller based on the determined values of the one or more parameters of interest. The control commands cause the process controller to change the state of the process (e.g., stop the etch process, change the diffusivity, etc.). In one example, a control command causes a process controller to adjust the focus of a lithographic system, a dosage of the lithographic system, or both. In another example, a control command causes a process controller to change the etch rate to improve measured wafer uniformity of a CD parameter.

In some examples, the measurement models are implemented as an element of a SpectraShape® optical critical-dimension metrology system available from KLA-Tencor Corporation, Milpitas, California, USA. In this manner, the model is created and ready for use immediately after the spectra are collected by the system.

In some other examples, the measurement models are implemented off-line, for example, by a computing system implementing AcuShape® software available from KLA-Tencor Corporation, Milpitas, California, USA. The resulting, trained model may be incorporated as an element of an AcuShape® library that is accessible by a metrology system performing measurements.

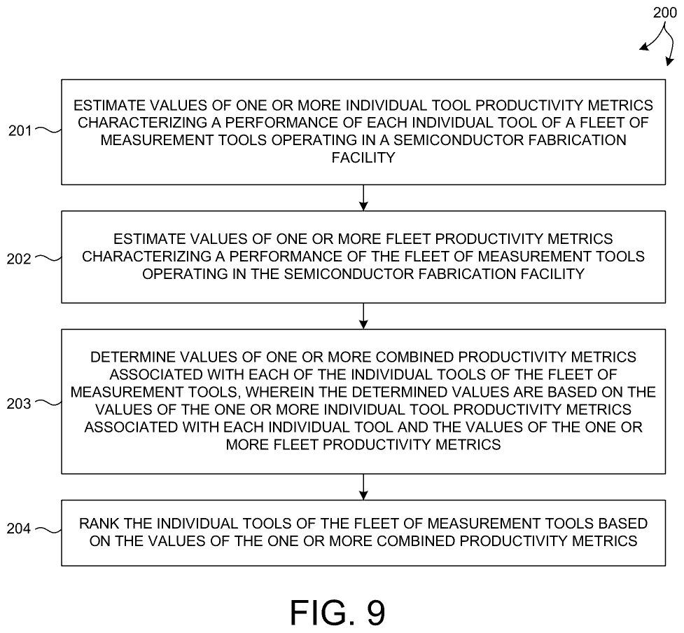

FIG. 9 illustrates a method 200 for evaluating the productivity of a fleet of semiconductor measurement systems in at least one novel aspect. Method 200 is suitable for implementation by a metrology system such as metrology system 100 illustrated in FIG. 1 of the present invention. In one aspect, it is recognized that data processing blocks of method 200 may be carried out via a pre-programmed algorithm executed by one or more processors of computing system 130, or any other general purpose computing system. It is recognized herein that the particular structural aspects of metrology system 100 do not represent limitations and should be interpreted as illustrative only.

In block 201, values of one or more individual tool productivity metrics characterizing a performance of each individual tool of a fleet of measurement tools operating in a semiconductor fabrication facility are estimated.

In block 202, values of one or more fleet productivity metrics characterizing a performance of the fleet of measurement tools operating in the semiconductor fabrication facility are estimated.

In block 203, values of one or more combined productivity metrics associated with each of the individual tools of the fleet of measurement tools are determined. The determined values are based on the values of the one or more individual tool productivity metrics associated with each individual tool and the values of the one or more fleet productivity metrics.

In block 204, the individual tools of the fleet of measurement tools are ranked based on the values of the one or more combined productivity metrics.

In a further embodiment, system 100 includes one or more computing systems 130 employed to perform measurements of semiconductor structures based on measurement data in accordance with the methods described herein. The one or more computing systems 130 may be communicatively coupled to one or more detectors, active optical elements, process controllers, etc.

It should be recognized that one or more steps described throughout the present disclosure may be carried out by a single computer system 130 or, alternatively, a multiple computer system 130. Moreover, different subsystems of system 100 may include a computer system suitable for carrying out at least a portion of the steps described herein. Therefore, the aforementioned description should not be interpreted as a limitation on the present invention but merely an illustration.

In addition, the computer system 130 may be communicatively coupled to other elements of a metrology system in any manner known in the art. For example, the one or more computing systems 130 may be coupled to computing systems associated with the detectors. In another example, the detectors may be controlled directly by a single computer system coupled to computer system 130.

The computer system 130 of system 100 may be configured to receive and/or acquire data or information from the subsystems of the system (e.g., detectors and the like) by a transmission medium that may include wireline and/or wireless portions. In this manner, the transmission medium may serve as a data link between the computer system 130 and other subsystems of system 100.

Computer system 130 of system 100 may be configured to receive and/or acquire data or information (e.g., measurement results, modeling inputs, modeling results, reference measurement results, etc.) from other systems by a transmission medium that may include wireline and/or wireless portions. In this manner, the transmission medium may serve as a data link between the computer system 130 and other systems (e.g., memory on-board system 100, external memory, or other external systems). For example, the computing system 130 may be configured to receive measurement data from a storage medium (i.e., memory 132 or an external memory) via a data link. For instance, measurement results obtained using the detectors described herein may be stored in a permanent or semi-permanent memory device (e.g., memory 132 or an external memory). In this regard, the measurement results may be imported from on-board memory or from an external memory system. Moreover, the computer system 130 may send data to other systems via a transmission medium. For instance, a measurement model or an estimated parameter value determined by computer system 130 may be communicated and stored in an external memory. In this regard, measurement results may be exported to another system.

Computing system 130 may include, but is not limited to, a personal computer system, mainframe computer system, workstation, image computer, parallel processor, or any other device known in the art. In general, the term “computing system” may be broadly defined to encompass any device having one or more processors, which execute instructions from a memory medium.

Program instructions 134 implementing methods such as those described herein may be transmitted over a transmission medium such as a wire, cable, or wireless transmission link. For example, as illustrated in FIG. 1, program instructions 134 stored in memory 132 are transmitted to processor 131 over bus 133. Program instructions 134 are stored in a computer readable medium (e.g., memory 132). Exemplary computer-readable media include read-only memory, a random access memory, a magnetic or optical disk, or a magnetic tape.

As described herein, the term “critical dimension” includes any critical dimension of a structure (e.g., bottom critical dimension, middle critical dimension, top critical dimension, sidewall angle, grating height, etc.), a critical dimension between any two or more structures (e.g., distance between two structures), and a displacement between two or more structures (e.g., overlay displacement between overlaying grating structures, etc.). Structures may include three dimensional structures, patterned structures, overlay structures, etc.

As described herein, the term “critical dimension application” or “critical dimension measurement application” includes any critical dimension measurement.

As described herein, the term “metrology system” includes any system employed at least in part to characterize a specimen in any aspect, including measurement applications such as critical dimension metrology, overlay metrology, focus/dosage metrology, and composition metrology. However, such terms of art do not limit the scope of the term “metrology system” as described herein. In addition, the system 100 may be configured for measurement of patterned wafers and/or unpatterned wafers. The metrology system may be configured as a LED inspection tool, edge inspection tool, backside inspection tool, macro-inspection tool, or multi-mode inspection tool (involving data from one or more platforms simultaneously), and any other metrology or inspection tool that benefits from the techniques described herein.

Various embodiments are described herein for a semiconductor measurement system that may be used for measuring a specimen within any semiconductor processing tool (e.g., an inspection system or a lithography system). The term “specimen” is used herein to refer to a wafer, a reticle, or any other sample that may be processed (e.g., printed or inspected for defects) by means known in the art.

As used herein, the term “wafer” generally refers to substrates formed of a semiconductor or non-semiconductor material. Examples include, but are not limited to, monocrystalline silicon, gallium arsenide, and indium phosphide. Such substrates may be commonly found and/or processed in semiconductor fabrication facilities. In some cases, a wafer may include only the substrate (i.e., bare wafer). Alternatively, a wafer may include one or more layers of different materials formed upon a substrate. One or more layers formed on a wafer may be “patterned” or “unpatterned.” For example, a wafer may include a plurality of dies having repeatable pattern features.

A “reticle” may be a reticle at any stage of a reticle fabrication process, or a completed reticle that may or may not be released for use in a semiconductor fabrication facility. A reticle, or a “mask,” is generally defined as a substantially transparent substrate having substantially opaque regions formed thereon and configured in a pattern. The substrate may include, for example, a glass material such as amorphous SiO₂. A reticle may be disposed above a resist-covered wafer during an exposure step of a lithography process such that the pattern on the reticle may be transferred to the resist.

One or more layers formed on a wafer may be patterned or unpatterned. For example, a wafer may include a plurality of dies, each having repeatable pattern features. Formation and processing of such layers of material may ultimately result in completed devices. Many different types of devices may be formed on a wafer, and the term wafer as used herein is intended to encompass a wafer on which any type of device known in the art is being fabricated.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. A method comprising:
estimating values of one or more individual tool productivity metrics characterizing a performance of each individual tool of a fleet of measurement tools operating in a semiconductor fabrication facility;
estimating values of one or more fleet productivity metrics characterizing a performance of the fleet of measurement tools operating in the semiconductor fabrication facility;
determining values of one or more combined productivity metrics associated with each of the individual tools of the fleet of measurement tools, wherein the determined values are based on the values of the one or more individual tool productivity metrics associated with each individual tool and the values of the one or more fleet productivity metrics; and
ranking the individual tools of the fleet of measurement tools based on the values of the one or more combined productivity metrics.

2. The method of claim 1, wherein the determining of the values of one or more combined productivity metrics associated with each of the individual tools of the fleet of measurement tools involves determining a statistical distance between values of an individual tool productivity metric associated an individual tool of the fleet of measurement tools and values of a fleet productivity metric associated with the fleet of measurement tools.

3. The method of claim 1, further comprising:
selecting an individual tool for maintenance based on the value of the one or more combined productivity metrics associated with the individual tool.

4. The method of claim 1, further comprising:
determining a difference between the values of the one or more individual tool productivity metrics associated with each individual tool and an average value of the values of the one or more individual tool productivity metrics associated with the individual tools comprising the fleet of measurement tools; and
selecting an individual tool for maintenance based on the determined difference and the values of the one or more combined productivity metrics associated with the individual tool.

5. The method of claim 1, wherein the performance of each individual tool of the fleet of measurement tools is a tool downtime rate, a duration of tool downtime, a tool reset rate, a time between scheduled resets, a time between unscheduled resets, or any combination thereof.

6. The method of claim 1, wherein at least one of the one or more individual tool productivity metrics characterizing the performance of each individual tool of the fleet of measurement tools is a statistically based metric.

7. The method of claim 1, wherein at least one of the one or more individual tool productivity metrics characterizing the performance of each individual tool of the fleet of measurement tools is a parameter of an analytical or machine-learning based model.

8. The method of claim 1, further comprising:
estimating a value of an accuracy metric indicative of a confidence in the ranking of an individual tool among the fleet of measurement tools.

9. The method of claim 1, further comprising:
predicting a probability of a future failure event associated with at least one individual tool of the fleet of measurement tools based on a difference between a predicted probability distribution of the failure event and an actual, observed distribution of the failure event.

10. The method of claim 1, wherein each individual tool of the fleet of measurement tools is any of a spectroscopic ellipsometer, a spectroscopic reflectometer, a soft X-ray reflectometer, a small-angle x-ray scatterometer, an imaging system, a hyperspectral imaging system, and a scatterometry overlay metrology system.

11. A system comprising:
an illumination source configured to provide an amount of illumination radiation to one or more structures disposed on a semiconductor wafer;
a detector configured to receive an amount of collected radiation from the one or more structures in response to the amount of illumination radiation and generate measurement signals indicative of the collected radiation; and
one or more computer systems configured to:
estimate values of one or more individual tool productivity metrics characterizing a performance of each individual tool of a fleet of measurement tools operating in a semiconductor fabrication facility;
estimate values of one or more fleet productivity metrics characterizing a performance of the fleet of measurement tools operating in the semiconductor fabrication facility;
determine values of one or more combined productivity metrics associated with each of the individual tools of the fleet of measurement tools, wherein the determined values are based on the values of the one or more individual tool productivity metrics associated with each individual tool and the values of the one or more fleet productivity metrics; and
rank the individual tools of the fleet of measurement tools based on the values of the one or more combined productivity metrics.

12. The system of claim 11, wherein the determining of the values of one or more combined productivity metrics associated with each of the individual tools of the fleet of measurement tools involves determining a statistical distance between values of an individual tool productivity metric associated an individual tool of the fleet of measurement tools and values of a fleet productivity metric associated with the fleet of measurement tools.

13. The system of claim 11, the one or more computing systems further configured to:
select an individual tool for maintenance based on the value of the one or more combined productivity metrics associated with the individual tool.

14. The system of claim 11, the one or more computing systems further configured to:
estimate a value of an accuracy metric indicative of a confidence in the ranking of an individual tool among the fleet of measurement tools.

15. The system of claim 11, the one or more computing systems further configured to:
predict a probability of a future failure event associated with at least one individual tool of the fleet of measurement tools based on a difference between a predicted probability distribution of the failure event and an actual, observed distribution of the failure event.

16. A system comprising:
an illumination source configured to provide an amount of illumination radiation to one or more structures disposed on a semiconductor wafer;
a detector configured to receive an amount of collected radiation from the one or more structures in response to the amount of illumination radiation and generate measurement signals indicative of the collected radiation; and
a non-transitory, computer-readable medium storing computer-readable instructions, the computer-readable instructions, when executed by one or more processors of a computing system, cause the computing system to:
estimate values of one or more individual tool productivity metrics characterizing a performance of each individual tool of a fleet of measurement tools operating in a semiconductor fabrication facility;
estimate values of one or more fleet productivity metrics characterizing a performance of the fleet of measurement tools operating in the semiconductor fabrication facility;
determine values of one or more combined productivity metrics associated with each of the individual tools of the fleet of measurement tools, wherein the determined values are based on the values of the one or more individual tool productivity metrics associated with each individual tool and the values of the one or more fleet productivity metrics; and
rank the individual tools of the fleet of measurement tools based on the values of the one or more combined productivity metrics.

17. The system of claim 16, wherein the determining of the values of one or more combined productivity metrics associated with each of the individual tools of the fleet of measurement tools involves determining a statistical distance between values of an individual tool productivity metric associated an individual tool of the fleet of measurement tools and values of a fleet productivity metric associated with the fleet of measurement tools.

18. The system of claim 16, the non-transitory, computer-readable medium further storing computer-readable instructions, that when executed by the one or more processors, cause the computing system to:
select an individual tool for maintenance based on the value of the one or more combined productivity metrics associated with the individual tool.

19. The system of claim 16, the non-transitory, computer-readable medium further storing computer-readable instructions, that when executed by the one or more processors, cause the computing system to:
estimate a value of an accuracy metric indicative of a confidence in the ranking of an individual tool among the fleet of measurement tools.

20. The system of claim 16, the non-transitory, computer-readable medium further storing computer-readable instructions, that when executed by the one or more processors, cause the computing system to:
predict a probability of a future failure event associated with at least one individual tool of the fleet of measurement tools based on a difference between a predicted probability distribution of the failure event and an actual, observed distribution of the failure event.
